(19) United States
(12) Patent Application Publication
(10) Pub. No.: US 2023/0003028 A1
(43) Pub. Date: Jan. 5, 2023

(54) ROOFING PANELS WITH INTEGRATED WATERSHEDDING

(71) Applicant: BMIC LLC, Dallas, TX (US)

(72) Inventors: Daniel E. Boss, Morris Township, NJ (US); Trieu Nguyen, Plano, TX (US); Kevin A. Pollack, Dallas, TX (US); David Gennrich, Fitchburg, WI (US); Eric R. Anderson, Montclair, NJ (US); Matthew J. Poster, Madison, WI (US)

(21) Appl. No.: 17/782,241

(22) PCT Filed: Jan. 15, 2021
(86) PCT No.: PCT/US21/13652

§ 371 Date: Jun. 3, 2022

Related U.S. Application Data
(63) Continuation-in-part of application No. 17/103,998, filed on Nov. 25, 2020.
(60) Provisional application No. 62/962,298, filed on Jan. 17, 2020.

(51) Int. Cl. E04D 13/04; E04D 1/20; E04D 1/08; E04D 1/00; E04D 1/28

(52) U.S. Cl. CPC E04D 13/0481; E04D 1/20; E04D 1/08; E04D 1/2949; E04D 1/2918; E04D 1/28; E04D 2001/3423

(57) ABSTRACT

Panels with substantially integrated watershedding features may be installed on the roof a house or other structure in lieu of traditional roofing materials. The panels include a body formed from a mixture of filler materials and polymeric binder materials, which can include recycled materials, with watershedding features generally formed with and/or integrated with the panels. The panels also can be installed in overlapping courses along a roof with the watershedding features incorporated along one or more peripheral edges. The watershedding features of adjacent panels further can cooperated to collect and divert water away from the upper surfaces and/or away headlap and/or sidelap joints defined between the panels.

### REFERENCE TO RELATED APPLICATIONS

The present Patent Application is a continuation-in-part of U.S. patent application Ser. No. 17/103,998, filed Nov. 25, 2020, which claims the benefit of U.S. Provisional Application No. 62/940,448, filed Nov. 26, 2019 and U.S. Provisional Application No. 62/951,252, filed Dec. 20, 2019; and further claims the benefit of pending U.S. Provisional Patent Application No. 62/962,298, filed on Jan. 17, 2020.

### INCORPORATION BY REFERENCE

The disclosures made in U.S. patent application Ser. No. 17/103,998, filed Nov. 25, 2020, U.S. Provisional Application No. 62/940,448, filed Nov. 26, 2019, U.S. Provisional Application No. 62/951,252, filed Dec. 20, 2019; and U.S. Provisional Patent Application No. 62/962,298, filed on Jan. 17, 2020, are each specifically incorporated by reference herein as if set forth in their entireties.

### TECHNICAL FIELD

This disclosure relates generally to roofing systems or structures and roofing panels for buildings and more specifically to roofing systems or structures and roofing panels with integrated watershedding features.

### BACKGROUND

The application of roofing panels for forming a roof of a building or other building components, has long been a construction practice, particularly in commercial roofing. More recently, interest in applying this construction practice to sloped residential roofs, including slate, tile and/or asphalt shingle style roofs, has grown. Issues with traditional roofing panels include the fact that they can be blown off by wind and windblown rain can flow and leak between the panels. Thus, such roofing panels must be sealed along the junctions of individual panels after application, which can be done in a variety of ways including, for example, applying a roofing membrane over the panels, taping the junctions of the panels, applying a traditional shingled roof over the panels, and combinations thereof. All of these sealing options are labor intensive and subject to human error and deterioration over time. In addition, some existing roofing panels, such as used for slate or tile roofs, generally are rigid and often are subject to breakage, and further must be mounted on underling supporting substrates.

A need exists for roofing panels that, upon installation, collect and/or shed water without the need for ancillary sealing or roofing strategies, and/or which can incorporate design features that inherently provide effective watershedding at critical panel junctions while being easily installable on a roof deck. It is to the provision of such roofing panels that the present disclosure is primarily directed.

### SUMMARY

Briefly described, construction panels are constructed with integral water collection and shedding features. In embodiments, the panels can comprise roofing panels and can be installed as part of a roof structure, such as for a residential or commercial roof. The water collection and watershedding features of the panels further will be configured to align and cooperate so as to collect rainwater and shed the rainwater down the slope of and off the roof, and with the need for ancillary sealing strategies to be employed being substantially minimized or eliminated.

In one non-limiting, example embodiment, the panels can each include a body, having at least one watershedding feature defined along at least one of an upper surface, a lower surface, and/or one or more peripheral edge portions of the body. The at least one watershedding feature is configured to receive and direct water along a drainage path away from the base. The body of each of the panels generally will include one or more fillers, which can include recycled materials and/or inert material such as sand, perlite, sodium bentonite, asphalt, or other granular materials, mixed with at least one binder, which can include a polymer or mix of polymers. In some embodiments, the polymer material can include recycled plastic materials or plastic materials from other waste streams, as well as various binder adhesives and/or combinations thereof.

In some embodiments of the disclosure, a method of forming the panels is disclosed, wherein the filler material and binder material (which generally will be shredded or crushed, or otherwise provided as a granulate or particulate) will be combined together in a selected ratio to form a mixture that is extruded to form an extrudate. In embodiments, the extrudate can be extruded and pressed and/or cut to form panels, such as roofing panels, with watershedding features integrally formed along peripheral side portions or edged thereof. For example, the panels can be formed with an integrated drip edge, lip, trough, or other watershedding feature along one or more peripheral edges thereof, and cut to a selected length.

In still other embodiments of the method, the mixture can form a top layer of a panel, and then joined and pressed or otherwise combined and fused to a bottom layer or substrate. In further embodiments, a UV protective layer or other protective or decorative layer or coating (e.g. an impact resistant coating, etc.) also can be applied over an upper surface of the body of the panels.

In various embodiments, the watershedding features integrated with the body of each of the panels, or with one of the layers thereof, will comprise at least one of a flexible strip, a trough, or a cover strip located along adjacent peripheral edge portions of the bases of adjacent roofing panels. For example, in some embodiments, one or more peripheral edges of the panels can be formed with asymmetrical, raised or arching profiles configured to cooperatively fit and/or engage with the watershedding features of adjacent panels. The panels further can be installed in either direction and can be shifted to manage overlapping of the watershedding features, such as along the corners between adjacent panels. In some embodiments, the watershedding features also can include projections or offset protrusions or saddles along which fasteners can be placed to help secure the panels to the roof structure and provide additional wind protection.

In still other embodiments, the watershedding features of the panels can comprise a drip edge or lip seal extending along at least one side edge, with a water trough positioned to receive and direct water flows along a drainage path long a slope of the roof and away from the panels. In some embodiments, the drip edges or lip seals of adjacent panels further can be engaged in an overlapping and/or a hooked arrangement. In addition, a cover strip or capped seam can be mounted along a seam defined between adjacent panels.

In a further embodiment, each of the panels can include a body having watershedding features formed as rolled or sloped portions along peripheral edge portions thereof, and which will be configured to overlap with a corresponding rolled or sloped edge portion of an adjacent panel to define a headlap or sidelap seam between adjacent roofing panels. In still other embodiments, the body of each panel can be formed with a stepped or offset profile with a projecting portion along one side edge (e.g. along a lower or side edge) and a recessed area or potion along an opposing side edge (e.g. along an upper or side edge). The projecting portions will overlap corresponding recessed portions of adjacent panels, and can form headlap joints or seams along which fasteners can be applied to secure the panels to the rafters of the roof structure. Sealant materials also can be applied between the overlapping features.

In some other embodiments, the body of each of the panels can be formed with an upper surface adapted to be exposed to the environment, and a lower surface having a series of grooves, recesses or valleys that form part of the watershedding features. In addition, the body of each panel can be formed with hooked peripheral edges, or can include a frame positioned about its peripheral edges, defining drip edges, troughs or other features, will be arranged along one or more of the peripheral edges of the panels, and will be configured to collect and direct water along drainage paths. A cover also can be applied over the drip edges of adjacent roofing panels.

In still another aspect, a roof system, comprises a plurality of panels configured to extend across sections of a roof; wherein each of the panels comprises a body or base having upper and lower surfaces and a plurality of peripheral edges; and at least one water shedding feature positioned adjacent at least one of the plurality of peripheral edges of the base; wherein the at least one watershedding feature of each panel is configured cooperate with a corresponding watershedding feature of an adjacent panel to reduce migration of water between the sidelap or headlap seams between the adjacent ones of the roofing panels. In some embodiments, a cover or trough further can be positioned along the sidelap or headlap seams between adjacent panels and configured to overlap the water shedding features of adjacent panels.

A method of installing roofing panels with watershedding features also is disclosed. In some aspects, the method can include arranging a plurality of roofing panels in spaced series, and coupling adjacent ones of the roofing panels along sidelap or headlap seams with the watershedding features of the roofing panels in an overlapping or engaging arrangement to collect and direct water flows along a drainage path and away from the roofing panels. In addition, the panels can be arranged in various orientations, including being arranged with their length extending in a horizontal direction, in a vertical direction, or diagonally. Other arrangements also can be used.

The foregoing and other advantages and aspects of the embodiments of the present disclosure will become apparent and more readily appreciated from the following detailed description and the claims, taken in conjunction with the accompanying drawings. Moreover, it is to be understood that both the foregoing summary of the disclosure and the following detailed description are exemplary and intended to provide further explanation without limiting the scope of the disclosure.

### BRIEF DESCRIPTION OF THE DRAWINGS

The accompanying drawings, which are included to provide a further understanding of the embodiments of the present disclosure, are incorporated in and constitute a part of this specification, illustrate embodiments of this disclosure, and together with the detailed description, serve to explain the principles of the embodiments discussed herein. No attempt is made to show structural details of this disclosure in more detail than may be necessary for a fundamental understanding of the exemplary embodiments discussed herein and the various ways in which they may be practiced.

FIGS. 1a and 1b are perspective views of embodiments of panels, such as for use as roofing panels, which have integrated watershedding features, formed according to principles of the present disclosure.

FIG. 2a is a perspective view illustrating an embodiment of a series of panels having integrated watershedding features arranged in an array as part of a roof structure, in accordance with the principles of the present disclosure.

FIG. 2b is a perspective view schematically illustrating an embodiment of watershedding features of the panels of FIG. 2a.

FIG. 2c is a perspective view schematically illustrating an additional embodiment of watershedding features of the panels of FIG. 2a.

FIG. 3a is a perspective view illustrating another embodiment of panels having integrated watershedding features, with the panels arranged in an array as part of a roof structure, in accordance with the principles of the present disclosure.

FIG. 3b is a perspective view schematically illustrating an embodiment of watershedding features of the panels of FIG. 3a.

FIG. 4a is a perspective view illustrating another embodiment of panels having integrated watershedding features, with the panels arranged in an array as part of a roof structure, in accordance with the principles of the present disclosure.

FIG. 4b is a perspective view schematically illustrating an embodiment of watershedding features of the panels of FIG. 4a including a water trough.

FIG. 4c is an end view of the panels shown in FIGS. 4a-4b.

FIG. 5a is a perspective view illustrating another embodiment of panels having integrated watershedding features, with the panels arranged in an array as part of a roof structure, in accordance with the principles of the present disclosure.

FIG. 5b is a perspective view schematically illustrating an embodiment of watershedding features of the panels of FIG. 4a including a capped seam.

FIG. 5c is an end view of the panels shown in FIGS. 5a-5b.

FIGS. 6a-6b are perspective views illustrating panels with roll formed watershedding features according to another embodiment of the present disclosure.

FIG. 7a is a perspective view illustrating still another embodiment of panels having integrated watershedding features formed as stepped features, and with the panels arranged in an array as part of a roof structure, in accordance with the principles of the present disclosure.

FIGS. 7b-7d are end views illustrating alternative configurations of the panels of FIG. 7a.

FIGS. 7e-7F schematically illustrate an arrangement of the panels of FIGS. 7a-7d in an alternate embodiment according to the principles of the present disclosure.

FIG. 8a is an end view illustrating still further embodiment of panels having integrated watershedding features in accordance with the principles of the present disclosure.

FIGS. 8b-8d illustrate embodiments of arrangements of the panels of FIG. 8a as part of a roof structure in accordance with the principles of the present disclosure.

FIGS. 9a-9c illustrate embodiments of panels having integrated watershedding features in accordance with the principles of the present disclosure being installed along rafters of a roof structure.

FIGS. 10a-10c illustrate an additional embodiment of panels having integrated watershedding features in accordance with the principles of the present disclosure being installed along rafters of a roof structure.

FIGS. 11a-11d schematically illustrate the installation of panels formed in accordance with the principles of the present disclosure to form a roof.

FIGS. 12a-12b schematically illustrate another example embodiment of an installation of panels formed in accordance with the principles of the present disclosure in an alternative, angled orientation to form a roof.

FIG. 13a schematically illustrates an example embodiment of the formation of panels in accordance with the principles of the present disclosure.

FIG. 13b schematically illustrates an installation of panels such as formed in accordance FIG. 13a as part of a roof structure.

### DETAILED DESCRIPTION

The following description is provided as an enabling teaching of embodiments of this disclosure. Those skilled in the relevant art will recognize that many changes can be made to the embodiments described, while still obtaining the beneficial results. It will also be apparent that some of the desired benefits of the embodiments described can be obtained by selecting some of the features of the embodiments without utilizing other features. Accordingly, those who work in the art will recognize that many modifications and adaptations to the embodiments described are possible and may even be desirable in certain circumstances. Thus, the following description is provided as illustrative of the principles of the embodiments of the disclosure and not in limitation thereof, since the scope of the present disclosure is defined by the claims.

The panels of the present disclosure can be used in various aspects for construction of buildings or other structures, such as for walls, roofs, etc. For purposes of illustration and not limitation, the panels are shown as roofing panels that include, in numerous embodiments, integrated features for waterproofing and shedding rainwater from sidelap seams of horizontally adjacent roofing panels and headlap seams of roofing panels in vertically adjacent courses. In embodiments, the watershedding features generally will be formed with and/or otherwise integrated as a part of the roofing panels at a manufacturing facility (prefab). The watershedding features disclosed herein also can be applied to a variety of roofing systems including, but not limited to panels, tiles, slate roofing, or metal roofing just to name a few.

The body of each panel further generally will be formed with sufficient strength or structural supporting properties so as to extend across a span or space between adjacent rafters of the roof structure on which the panels are installed. For example, in some embodiments, the panels can be configured to extend across a larger span or space, such as extending between an eave or building wall and a peak of the roof, and/or across the roof structure sufficient to reduce the number of rafters for the roof structure. The panels also can have nail sealing properties to resist or retard passage of water through fastener openings formed therethrough.

Referring to the drawing figures, various embodiments of roofing panels according to principles of the present disclosure can be configured to be installed on a roof in a variety of configurations. For example, the roofing panels can be attached atop and extend across a span between rafters of a roof, having sufficient strength to support weight without necessarily requiring a supporting plywood roof deck therebelow. Alternatively, the panels can be formed as structural roofing panels can replace the plywood deck and at least some of the supporting rafters and trusses of a roof. For example, the roofing panels can comprise a structural insulated panel (SIP) of a configuration and/or size to extend across or along a span between one or more rafter or between a ridge or peak of the roof and an eave of the roof or a side wall of the building, sufficient to substantially eliminate rafters or reduce the number of rafters required for supplementing the structural integrity of the roof.

The use of the panels can provide numerous benefits including, but not limited to, the elimination of headlaps and consequently the need for headlap water shedding features. Horizontal seams, which may seem unsightly, also can be eliminated. Many of the sidelap water shedding feature embodiments described above may be used between horizontally adjacent panels in this embodiment. Another benefit is that these large roofing panels can be made sufficiently strong to provide their own structural support thus substantially eliminating or greatly reducing the need for trusses, rafters, and/or roof decks.

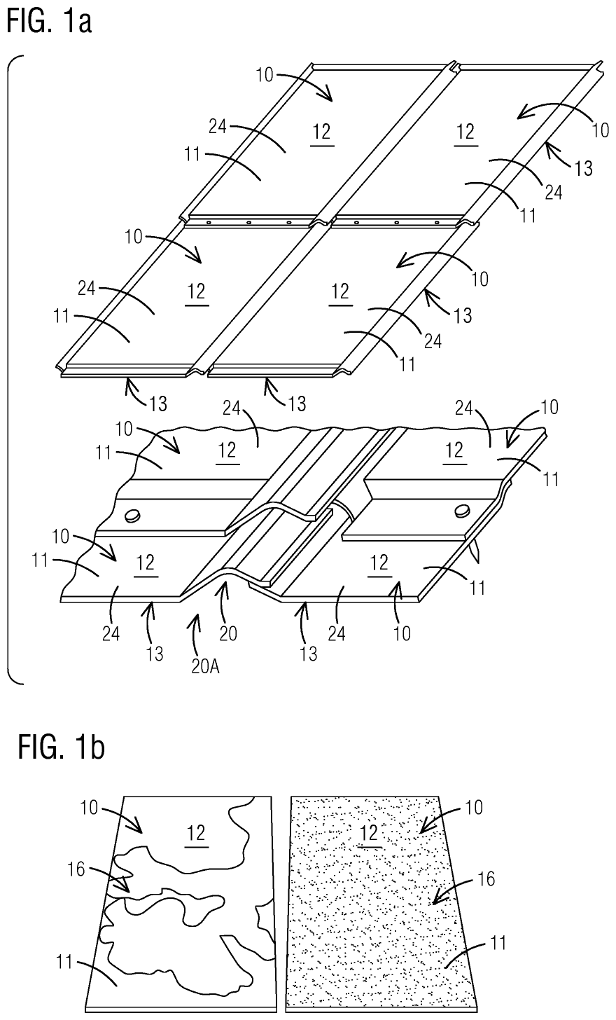

As indicated in the figures, such as, for example, FIGS. 1a-1b, the roofing panels 10 can comprise a body or base 11 having upper and lower surfaces 12 and 13 and a series of peripheral portions or side edges 14. The panels 10 can be formed with various shapes or configurations. For example, as indicated in FIGS. 1a-1b, in some embodiments, the panels 10 can have substantially rectangular or square configurations, while in other embodiments, the panels can be form in triangular, hexagonal, octagonal or other shapes. In addition, in some embodiments, such as shown in FIG. 1b, the panels 10 also can be formed with textures, patterns, colors, tints or other selected aesthetic features 16; for example, in some non-limiting embodiments, being formed as a slate or roman tile, or with the appearance of other roofing products.

The body 11 of each of the panels 10 generally will include one or more fillers, which can include recycled materials (e.g. recycled shingle granules or other recycled, granulated materials) and/or inert materials, mixed with at least one binder, which can include a polymer or mix of polymers. In some embodiments, the polymer material can include recycled plastic materials and/or plastic materials from other waste streams, as well as various binder adhesives and/or combinations thereof.

For example, but without limitation, the filler material can include inert and recycled materials such as sand, granules, crushed, pulverized and/or shredded asphalt shingles, granules reclaimed from shingle recycling, dust byproducts, cement, aggregates, sodium bentonite, bentonite clay, rice hulls, perlite, hemp, foaming agent, cellulose, among other materials. The filler materials generally can be crushed or pulverized to a size or ⅛″ or less to promote flowability and mixing. Other sizes of granules or particulate fillers also can be used as needed or desired. The filler materials further can be selected to provide sufficient texture to provide a slip resistant upper surface 24 for each of the panels 10 for walking.

In addition, the binder materials for the mixture can include various recycled polymer or plastic materials, including recycled plastics, mixed plastics, commingled plastics, unwashed plastics, plastic films, contaminated plastics. For example, in some non-limiting embodiments, recycled low density polyethylene (LDPE) films such as found in recycled grocery bags, linear low density polyethylene (LLDPE) films, high density polyethylene (HDPE) films, or polypropylene films can be used. In other, non-limiting embodiments, materials such as recycled agricultural films (which can include hay bale wraps, greenhouse films and/or geotextiles or geo-membranes that can have some UV protection remaining) can be used. In still further non-limiting embodiments, in place of melting polymers or plastic materials, oriented strand board binders (such as polyurea, urea formaldehyde, phenolic resins, Amino resins, or wax emulsions, etc.), or starches (e.g. dextrin), lignin's, adhesives, asphaltic binders, cement, adhesives, and/or combinations thereof, also could be used.

The granulated filler materials will be mixed with a selected binder material or a mixture of selected binder materials in a desired ratio. By way of example, and without limitation, in some aspects, a polymer or plastic material such as LDPE can be shredded or crushed and mixed with the granulated filler material in a ratio of 1:1, or 2:1, or 3:1, or 4:1 or 5:1. Other ratios of the binder materials to the filler materials also can be used.

By way of illustration and not limitation, various achievable filler:binder ratios can be determined based upon factors such as a selection of the filler and the binder materials being used, the manufacturing process used for the selected roofing panel material and/or use thereof, the desired mechanical properties of the roofing panel material, and the cost target of the material, and/or combinations thereof. For example, samples were developed using sand and recycled polymer materials, and were developed having an approximately ˜3:1 ratio based upon manufacturing or processing. However, such a limitation may not exist for a different filler and binder material combination, which therefore may have a different ratio.

In some embodiments, the polymer binder materials of the panels may or may not include other additives such as UV blockers, fire retardants, compatibilizers, and/or combinations thereof. Alternatively, or in addition, the upper surface of the body of each panel also can have a protective layer or coating applied thereover to provide UV protection, impact protection, cut resistance and/or other properties.

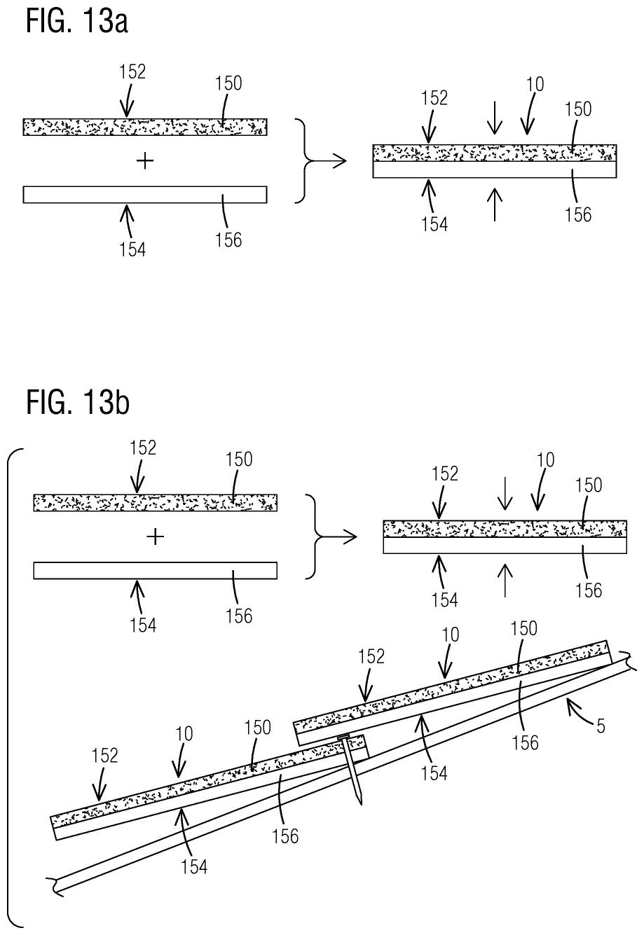

In embodiments, the thickness of the roofing panels can vary based on the structural requirements of a given installation and other factors, such as the material properties of the mixture of the filler and binder materials used. In some embodiments, the extruded portion of the panel may be between ⅛″ to 2,″ with additional thicknesses possible if rigid underlayers are included, such as illustrated in FIGS. 13a-13b. In other embodiments, the panels can have a thickness of ⅛″ to 1½″, ⅛″ to 1″, ⅛″ to ¾″, or ⅛to ½″. Other thicknesses also can be used. The sizes of the panels also could range from a small panel such as the size of a 12″×36″ shingle or the size of a clay tile, to a larger panel approximately 48″×96″. Various other sizes and/or configurations, for example, ranging from approximately 20″×44″ to 50″×100″, although other sizes also can be used.

As further illustrated in FIGS. 1a and 2a-10c, the panels 10 will be formed with integrated watershedding features 20, with the watershedding features 20 generally being located along at least one peripheral edge portion 11A/11B of the body 11 of each panel 10, and configured to direct water along at least one drainage path 20A and away from seams or joints, such as headlap and/or sidelap joints or seams 21 and 22 formed between adjacent installed panels 10. The watershedding features 20 of the panels 10 each further will be configured to cooperate with a corresponding watershedding feature 20 of an adjacent panel 10 to substantially seal the headlap and/or sidelap joints or seams 21/22 between adjacent installed panels and reduce migration of water between the adjacent installed panels.

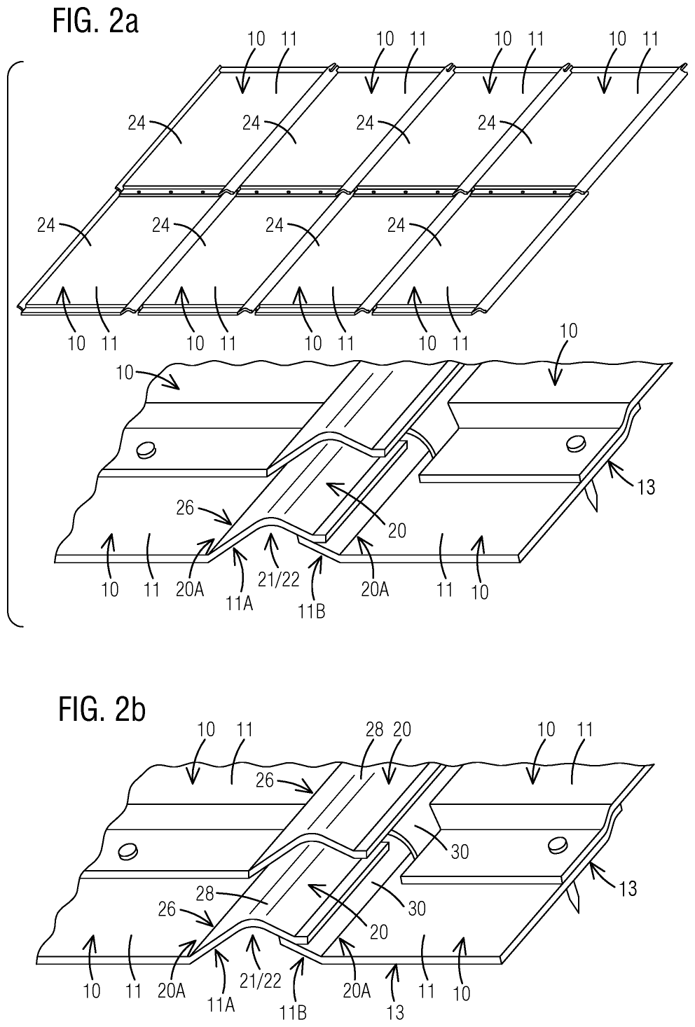

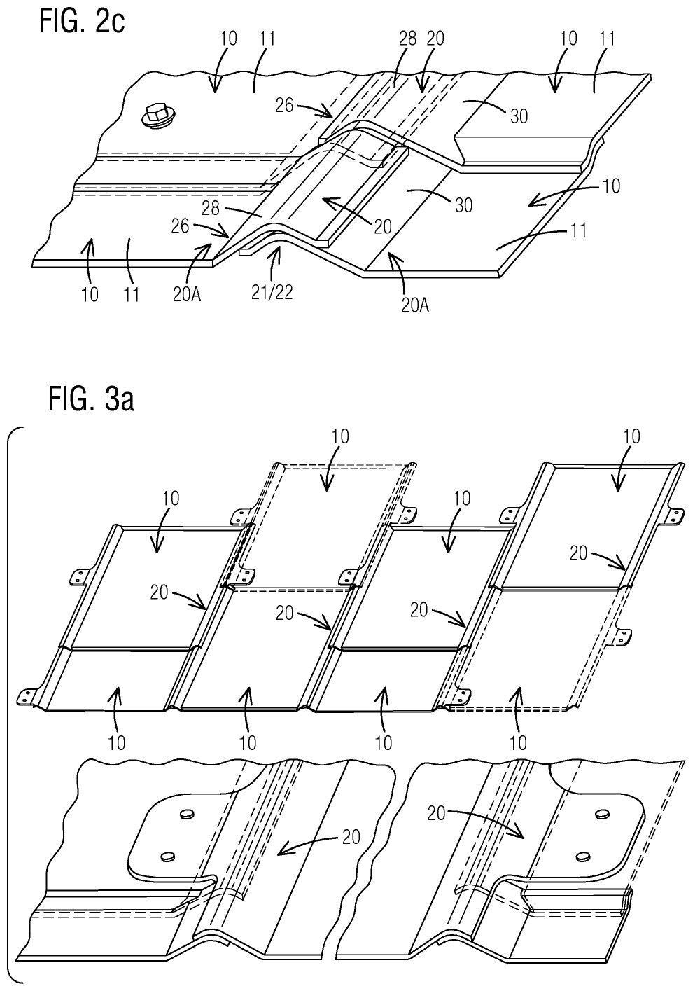

For example, in some embodiments, such as shown in FIGS. 2a-2c, one or more peripheral edges 26 of the panels 10 can include a body 28 formed with asymmetrical, raised, or arching profile or shape that is configured to cooperatively fit and/or engage with corresponding or complementary shaped body 30 or other watershedding features of adjacent panels. The panels 10 further can be installed in either direction and can be shifted to manage overlapping of the watershedding features 20, such as along the corners between adjacent panels.

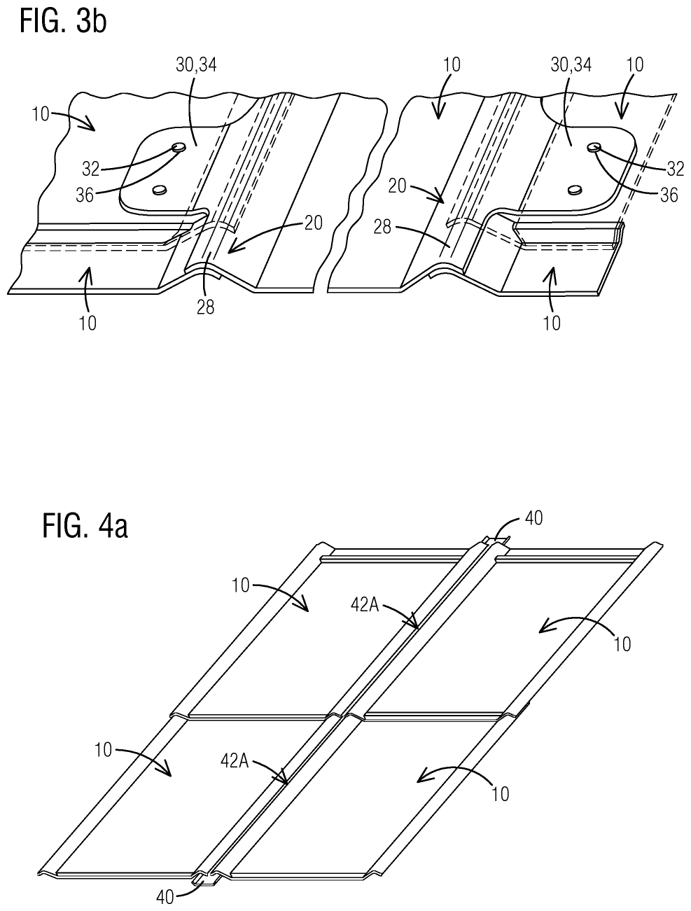

As illustrated in FIGS. 3a-3b, the watershedding features 20, in some embodiments, also can include projections or protrusions or saddles 30 along which fasteners 32 can be placed to help secure the panels 10 to the roof structure and provide additional wind protection. The projections 30 can be formed with or otherwise connected to the watershedding features 20 (e.g., the body 28 with the arching profile or shape), and can include a projection body 34 with a plurality of openings or apertures 36 defined therein for receiving the fasteners 32. The fasteners 32 can include nails, screws, other fasteners, or combinations thereof.

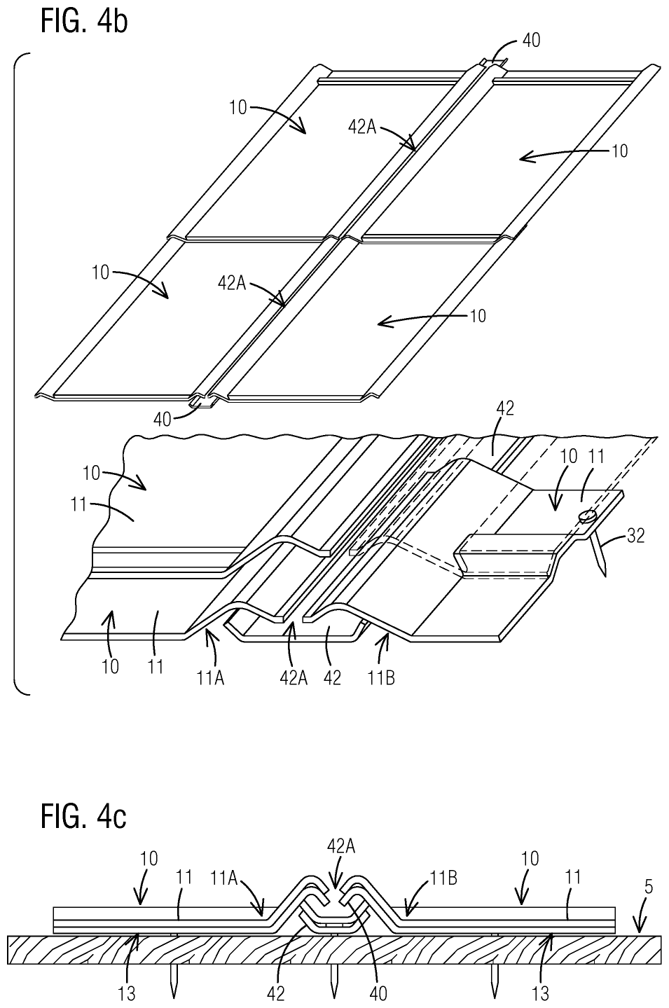

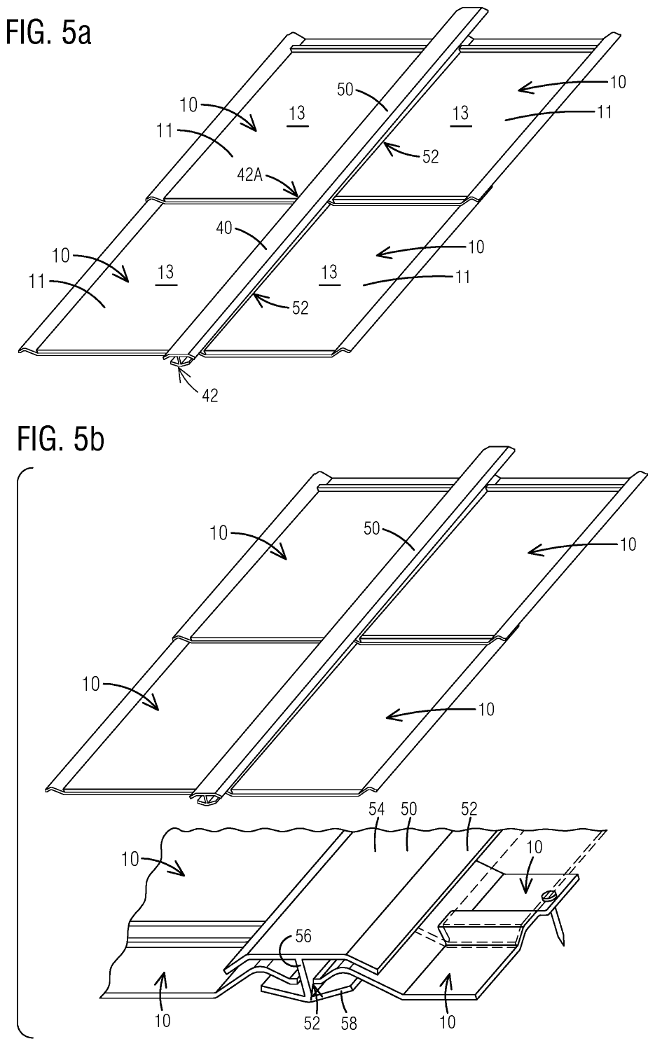

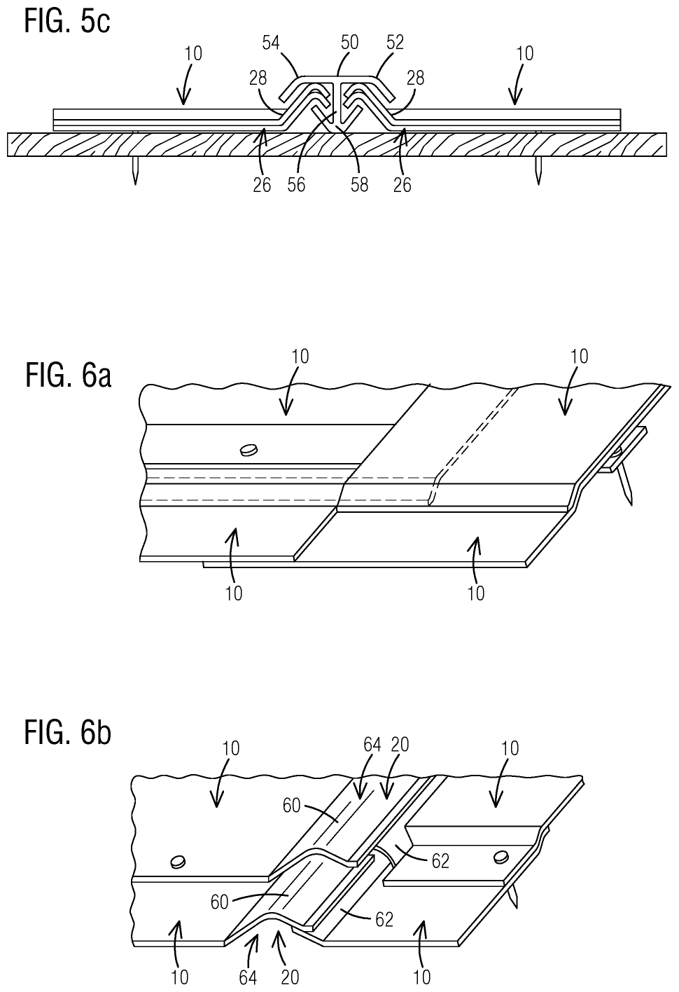

In still other embodiments such as shown in FIGS. 4a-5c, the watershedding features 20 of the panels 10 can comprise a drip edge or lip seal 40 extending along the at least one side edge 11A/11B of their bodies 11, with a water trough 42 positioned to receive and direct water flows along a drainage path 42A along a slope of the roof 5 and away from the panels 10. The drip edges or lip seals 40 of adjacent panels 10 further can be engaged in an overlapping and/or a hooked arrangement.

In addition, as shown in FIGS. 5a-5c, the water trough 40 can be formed with a cover strip or capped seam member 50, which can be mounted along a seam 52 defined between adjacent panels 10. The capped seam member 50 can include a body 52 that includes an upper portion 54, a middle portion 56, and a lower portion 58. The upper portion 54 is configured to be received over the bodies 28 of peripheral edges 26 of adjacent panels 10. The lower portion 58 is configured to be received under the bodies 28 of peripheral edges 26 of adjacent panels 10. The middle portion can include a flange that is configured to be received between the bodies 28 of peripheral edges 26 of adjacent panels 10 and connect the upper and lower portions 54/58.

In a further embodiment shown in FIGS. 6a-6b, each of the panels can have watershedding features 20 including a body 60 formed as rolled or sloped portions along peripheral portions thereof, and which overlap with a corresponding rolled or stepped edge 62 of an adjacent roofing panel to define a headlap or sidelap seam 64 between adjacent roofing panels 10. Sealant can further be applied to resist water wicking upslope.

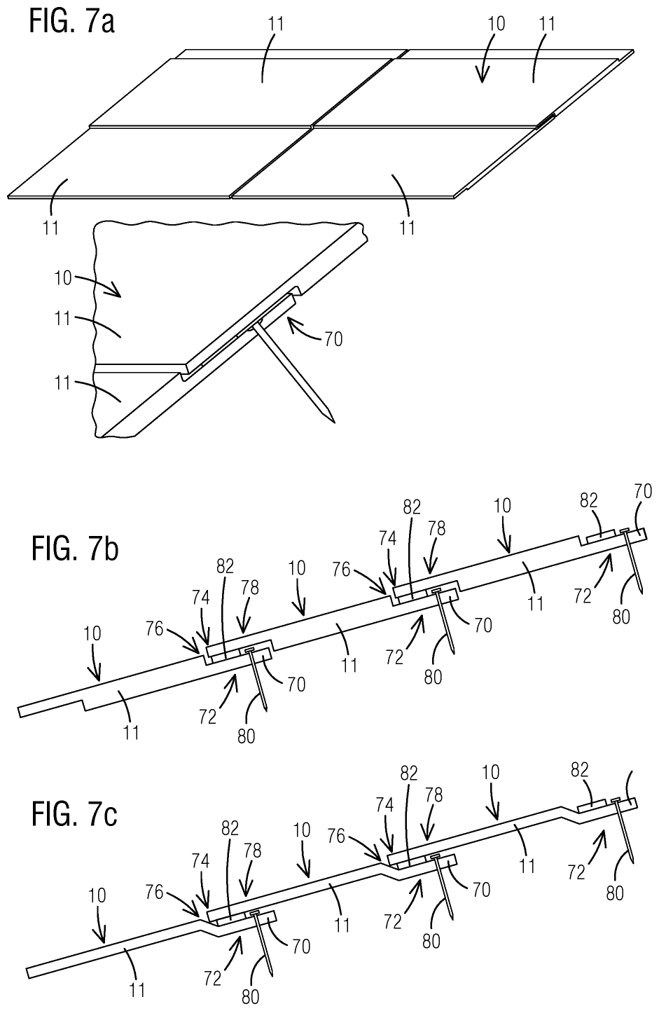

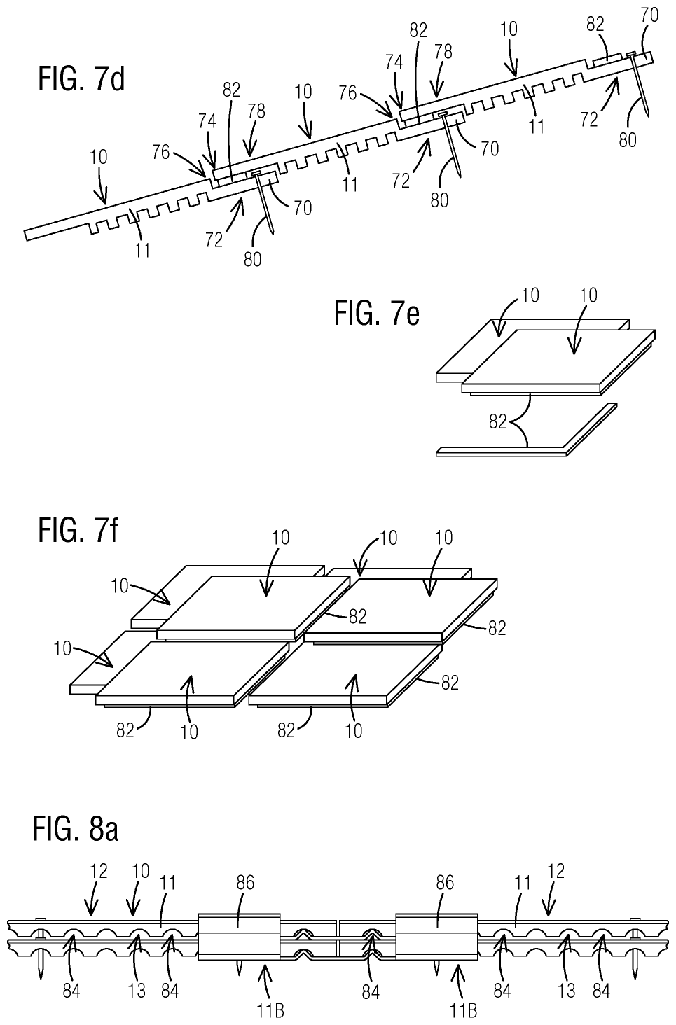

In other embodiments, as shown in FIGS. 7a-7f, the body 11 of each panel 10 can be formed with a stepped or offset profile with a projecting portion 70 along one side edge 72 (e.g. along a lower edge) and a recessed area or portion 74 along an opposing side edge 76 (e.g. along an upper edge). The projecting portions 70 overlap corresponding recessed portions 74 of adjacent panels 10, for example forming headlap joints or seams 78 along with fasteners 80 can be applied to secure the panels 10 to the rafters of the roof structure. The panels 10 also can be arranged in a diagonally offset arrangement and sealant materials 82 can be applied along the seams or joints 78. The sealant materials 82 can be applied to have a I-shaped configuration (FIG. 7f).

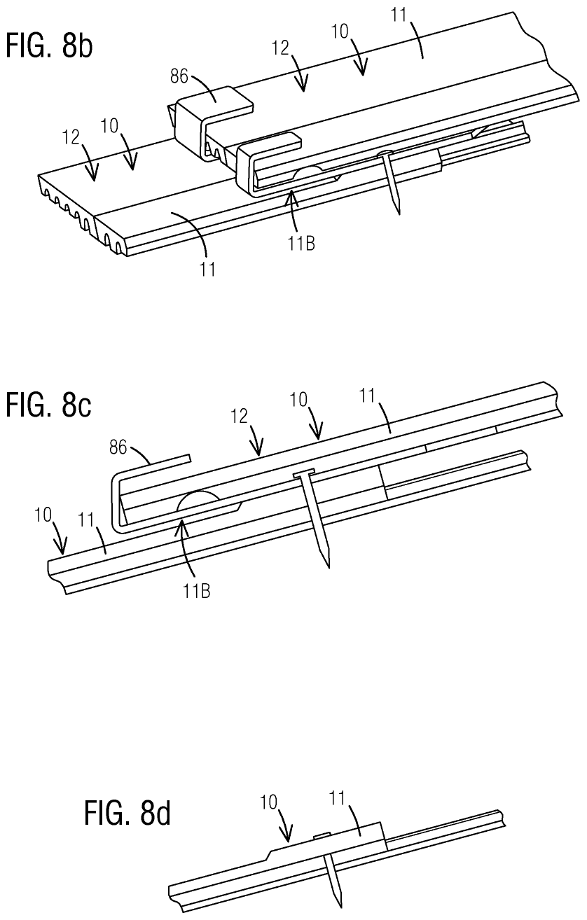

FIGS. 8a-8d show another embodiment of the panels 10 according to the present disclosure, wherein the body 11 of each of the panels 10 can be formed with an upper surface 12 adapted to be exposed to the environment, and a lower surface 13 having a series of grooves, recesses or valleys 84 that form part of the watershedding features. In addition, hooked frames 86, defining drip edges, troughs or other features, will be arranged along one or more of the peripheral edges 11B of the panels, and will be configured to collect and direct water along drainage paths. A cover also can be applied over the drip edges of adjacent roofing panels.

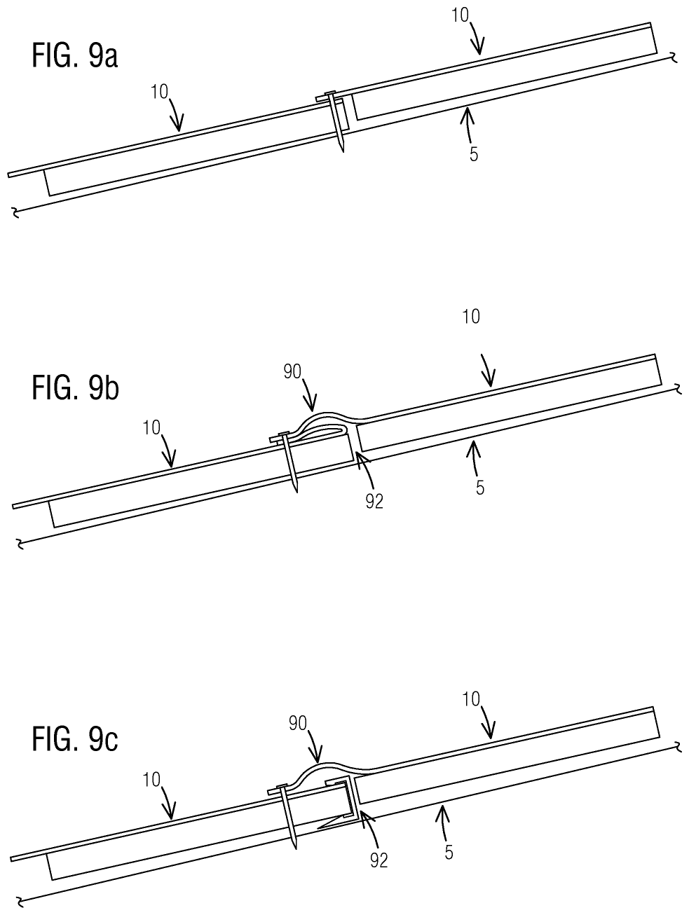

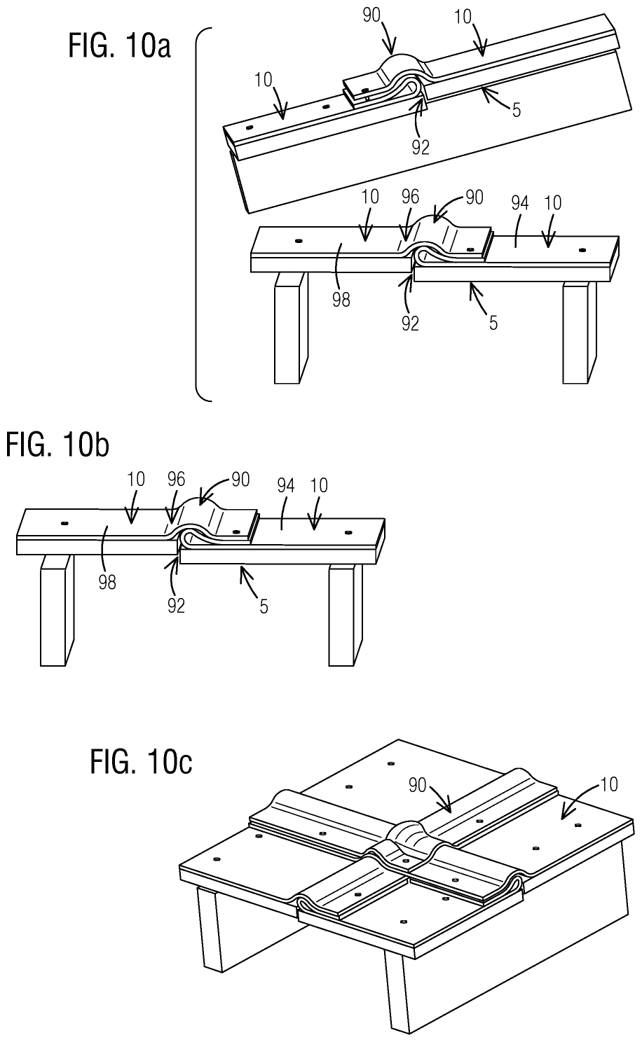

FIGS. 9a-10c illustrate still further embodiments of panels 10 having a folded or overlapping edge portion or projection 90 configured to overlap a joint or seam 92, such as a headlap joint or seam between adjacent panels 10 mounted in courses along the rafters of the roof structure 5. The edge portion 90 of a first panel 94 can be folded over itself, e.g., to form two or more layers, and an edge portion 96 of a second adjacent panel 98 can be received over the folded edge portion 90 of the first panel 94 (FIGS. 10a-10b).

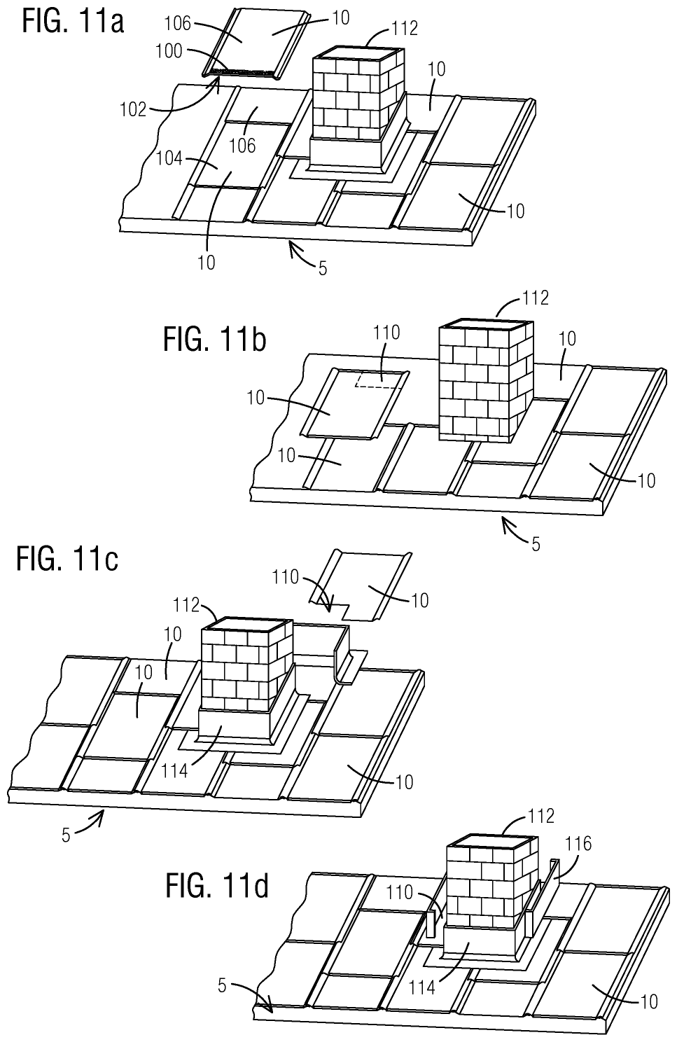

FIGS. 11a-11d illustrate an example embodiment of an installation method using panels 10 of the present disclosure. In the installation method, panels 10 can be applied to a roofing structure 5. As indicated in FIG. 11a, a sealant material 100 is provided along a bottom edge portion 102 of the panels 10, and adjacent panels 10 are installed with an overlap, e.g., a first, lower panel 104 can be applied to the roofing substrate 5 and a second, upper panel 106, with a sealant material 100 along a bottom edge portion 102 thereof, can be partially overlaid on the first panel 104 such that there is an overlap between the first and second panels 104/106. In embodiments, the overlap can have a width of 3 inches. Other overlap widths or sizes also can be used.

The panels 10 further can be measured and cut (e.g., to have removed areas 110) to correspond to or fit around obstructions 112, such as a chimney or other roofing feature (FIG. 11b). Measured panels 10 can be applied to the roofing substrate 5, e.g., as shown in FIG. 11a, to surround the obstruction 112, and prefabricated, flexible flashings 114 can be received about the obstruction (FIG. 11c). In addition, as FIG. 11d shows, counter flashing 116 can be applied over the prefabricated, flexible flashings, e.g., via caulking into grooves thereof. These panels 10 also can make use of simple overlaps at the headlap edges and at the sidelap edges to obtain mechanical water shedding at a lower cost. In one embodiment, the angled side edges of the panels match the hip and valley angles of the roof and the roofing panels are flippable to reduce the number of panel SKUs needed.

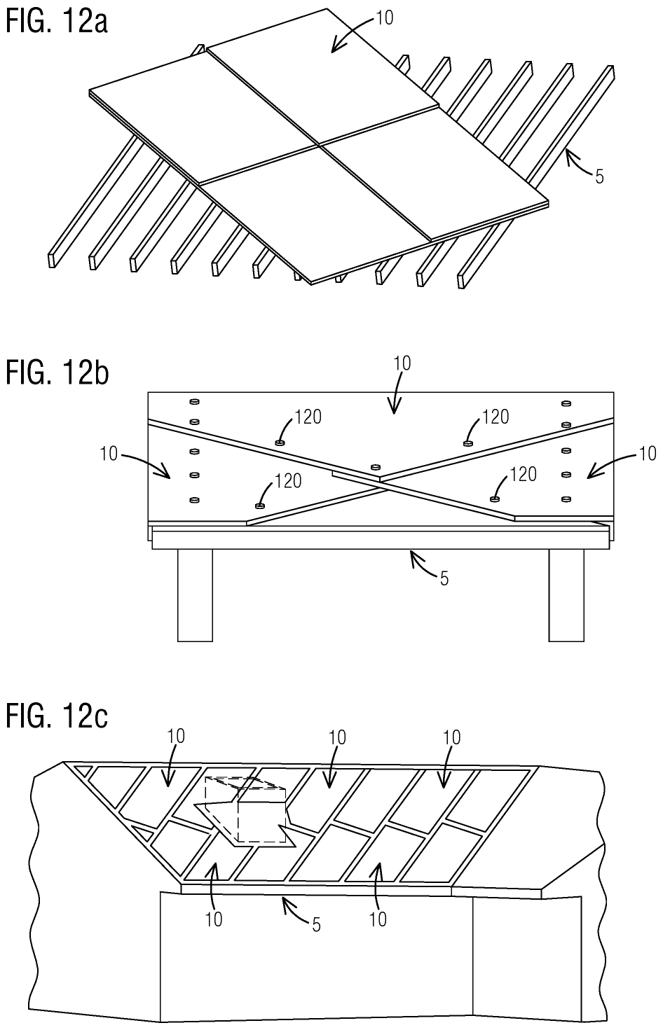

FIGS. 12a-12c illustrate an alternative arrangement of an installation method for installing the panels along a roof. In the FIGS. 12a-12c, panels 10 are applied to a roofing substrate 5 at an offset or angle. The roofing substrate can include a plurality of adjacent and generally parallel rafters or other roofing substrate. In this embodiment, panels 10 are arranged along the roofing substrate at a 45-degree angle. However, in addition or in the alternative, the panels can be arranged at other angles, such as 35 degrees, 40 degrees, 50 degrees, 55 degrees, and/or various other angles as needed to fit a roof geometry for the roof structure on which the panels are installed. Thereafter, the panels 10 are secured to the roofing substrate using fasteners 120, such as nails, screws, etc. at least two of the four sides of the panels, such that the panels do not peel up when experiencing wind loads.

In some embodiments of the disclosure, a method of forming the panels is disclosed, wherein the filler material and binder material 150 (which generally will be shredded or crushed, or otherwise provided as a granulate or particulate) will be combined together in a selected ratio to form a mixture that is extruded under heat to form an extrudate.

In embodiments, the extrudate can be extruded in the form of a panel, such as a roofing panel, with watershedding features integrally formed therewith. In other embodiments, the extrudate can be formed as a sheet that can be pressed or stamped and cut in a desired panel configuration, with the watershedding features formed therewith. For example, the panels can be formed with an integrated drip edge, lip, trough, or other watershedding feature along one or more peripheral edges thereof, and cut to a selected length.

In still other embodiments of the method, for example as shown in FIGS. 13a-13b, the mixture 150 can form a top layer or portion 152 of a panel 10, which can be formed separately from a bottom layer or portion 154, and then joined and pressed or otherwise combined and fused to the substrate 156. For example, the bottom portion 154 could comprise a flexible polymer sheet or bottom layer that can be formed (e.g. extruded) in a separate process from the formation of the extrudate or top layer, and then the two layers brought together and pressed while still at a temperature sufficient to enable the portions or layers to be substantially fused together to form the panel body. The formation of such panels can facilitation concentration of colorants, textures, granular and other filer materials adapted to provide performance and/or aesthetic characteristics such as slip resistance, UV protection.

In some embodiments, the substrate or bottom layer further could include more rigid materials, such as a plywood, metal, or other substantially rigid materials, over which the extrudate can be applied to form a panel body. In some embodiments, a UV protective layer or other protective layer (e.g. an impact resistant coating, etc.) also can be applied over an upper surface of the body of the panels.

In embodiments, the panels 10 will be formed in configurations that optimize size, shape, material usage, minimize overlaps, minimize the cutting required at obstructions, prevent windblown water leaks, increase speed of installation, enable using faster production processes, and prevent wind uplift. In addition, in some applications, a thinner tile can be less expensive. In order to reduce thickness, other manufacturing processes and material formulations can be used.

For example, the panels 10 can be sized or configured to match the size or configuration of a typical solar panel, e.g. 3.25 feet by 6.5 feet for a 72 cell panel. Any or all of the water shedding feature embodiments described above may be used in such panels. In addition, the panels can include a frame with releasable connectors, such as clips, snaps, magnets, hooks, fasteners, brackets/battens, or other connectors, enabling removal and replacement or change-out as needed. With such a sizing strategy, a waterproofing layer on the top of a panel can be replaced by a solar panel without changing or disturbing the water shedding capabilities of the installation.

In addition, adaptation of the water shedding feature concepts disclosed herein can be made to a green or living roof, which traditionally has been limited to low slope roofs. A roofing panel forming a framework or a tray sized to contain a layer of biological or vegetative, living material such as grass allows green roofs to be used on the steep slope roofs of residential houses as well. The growing material of each panel can be changed or replaced without disturbing the water shedding features and functions of the roof panel installation. For example, such a panel framework can include connectors that engage brackets, battens or other cooperative connectors arranged along the underlying roof structure (e.g. a roof deck or substrate, or rafters or other support beams), and also can include connectors configured to connect or interlock with adjacent panels. Such connectors can include, but are not limited to hooks, snap, magnets, clips, locking connectors, fasteners and/or other engageable and disengageable connectors.

In addition, the vegetative or “green” panels shown are to be understood as examples of various types of panels, which panels further can be made interchangeable, i.e., they can be snapped or changed by a homeowner, etc. . . . , and various other types of panels, including various types of “smart” or functional/decorative panels such as (but not limited to) energy panels configured to collect solar, wind, and heat energy, i.e. solar panels; panels configured for water collection and filtration; panels adapted to provide or configured with an antenna array; illuminating panels or panels with pre-installed lights; panels configured to enable roof access equipment, containing items such as a retractable ladder; skylight panels; panels configured for digital sensing/communications; decorative panels in solid colors, textures, patterns and/or customizable print options; panels incorporating traditional roofing materials and aesthetics; panels with storage chamber for parts and tools for easy repair/replacement; and/or various combinations thereof, can be exchanged or substituted therefor.

The foregoing description generally illustrates and describes various embodiments of the present disclosure. It will, however, be understood by those skilled in the art that various changes and modifications can be made to the above-discussed construction of the present disclosure without departing from the spirit and scope of the disclosure as disclosed herein, and that it is intended that all matter contained in the above description or shown in the accompanying drawings shall be interpreted as being illustrative, and not to be taken in a limiting sense. Furthermore, the scope of the present disclosure shall be construed to cover various modifications, combinations, additions, alterations, etc., above and to the above-described embodiments, which shall be considered to be within the scope of the present disclosure. Accordingly, various features and characteristics of the present disclosure as discussed herein may be selectively interchanged and applied to other illustrated and non-illustrated embodiments of the disclosure, and numerous variations, modifications, and additions further can be made thereto without departing from the spirit and scope of the present disclosure as set forth in the appended claims.

1. A roof structure, comprising:
a plurality of panels each configured to extend across a section of the roof structure, each panel comprising:
a body comprising a mixture including at least one filler material and at least one binder material;
wherein the at least one binder material comprises recycled plastics, mixed plastics, commingled plastics, unwashed plastics, plastic films, contaminated plastics, agricultural films and/or geotextiles or geo-membranes, oriented strand board binders, starches, lignins, adhesives, asphaltic binders, cement and/or combinations thereof; and
at least one watershedding feature located along at least one peripheral edge portion of the body and configured to convey water along at least one drainage path;
wherein the at least one watershedding feature of each panel is configured to cooperate with a corresponding watershedding feature of an adjacent panel to reduce migration of water between the panel and the adjacent panel.

2. The roof structure of claim 1, wherein the at least one filler material comprises an inert material, a recycled material, and/or combinations thereof.

3. The roof structure of claim 1, wherein the filler material comprises sand, perlite, sodium bentonite, asphalt shingle materials, concrete and/or combinations thereof.

4. The roof structure of claim 1, wherein the filler material comprises a recycled material, including recycled shingle materials, rice hulls, hemp, cellulose, foams and/or combinations thereof.

5. The roof structure of claim 1, wherein the at least one binder material comprises recycled low density polyethylene, linear low density polyethylene, high density polyethylene, polypropylene, polyurea, urea formaldehyde, phenolic resins, Amino resins, wax emulsions and/or combinations thereof.

6. The roof structure of claim 1, wherein the at least one watershedding feature further comprises at least one projection configured to overlap the body of the adjacent panel and provide an area for engagement of fasteners to secure the panel to the adjacent panel.

7. The roof structure of claim 1, wherein the body of each panel comprises a substantially self-sealing material adapted to substantially seal about fasteners inserted therethrough.

8. The roof structure of claim 1, wherein the at least one watershedding feature further comprises at least one of a drip edge, a trough, a ramp, or a cover located along a seam between the panel and the adjacent panel.

9. The roof structure of claim 1, wherein each of the panels is configured to extend between a ridge of the roof structure and an eave of the roof structure.

10. The roof structure of claim 9, wherein panels further comprise substantially self-supporting panels each having an upper end mounted to the ridge of the roof structure, and a lower end mounted to the eave of the roof structure, and wherein the at least one watershedding feature of each panel and each adjacent panel extends between the ridge and eave of the roof structure.

11. The roof structure of claim 1, wherein the mixture of the body comprises a top layer, and the body of each panel further comprises a bottom layer over which the mixture is applied, wherein the bottom layer comprises an oriented strand board (OSB), polyisocyanurate (ISO) plywood, foam board, structural foam, polystyrene, polyvinyl chloride (PVC) plastic, concrete, pressed recycled materials, structural insulated materials, or combinations thereof.

12. The roof structure of claim 1, further comprising a vapor barrier layer positioned along a bottom surface of each panel and configured to enable passage of moisture therethrough.

13. The roof structure of claim 1, wherein the body of each panel further comprises a stepped portion defining a headlap or sidelap portion and an overlap portion defining an opposing lower or sidelap portion of the body, and wherein the overlap portion of each panel or sidelap is configured to overlap the headlap or sidelap portion of the adjacent panel so as to define the at least one watershedding feature extending along a headlap or sidelap seam between the panel and the adjacent panel.

14. The roof structure of claim 1, wherein the at least one watershedding feature further comprises a drip edge or water trough positioned along at least one peripheral edge of the body, and a cover configured to be applied over and cover the drip edge and/or water trough of adjacent roofing panels.

15. The roof structure of claim 1, wherein each panel further comprises a protective layer along an upper surface thereof, the protective layer configured to provide ultraviolet protection, slip resistance, nail sealing properties, cut resistance, impact resistance, and/or combinations thereof.

16. A method of forming a roof, comprising:
arranging a plurality of roofing panels in spaced series across the roof, each roofing panel comprising:
a body comprising a mixture of a granular filler material mixed with a binder material extruded or melted and pressed to form the body with at least one integrally formed watershedding feature located along at least one peripheral edge thereof;
wherein the at least one watershedding feature of each roofing panel is configured to cooperate with a corresponding watershedding feature of an adjacent roofing panel to reduce migration of water between the roofing panel and the adjacent roofing panel; and
coupling each roofing panel to the adjacent roofing panel along a sidelap or a headlap seam with the at least one watershedding feature of roofing panel and the adjacent roofing panel in a cooperative engagement adapted to define a drainage path for migration of water away from the sidelap or headlap seam formed between the roofing panel and the adjacent roofing panel.

17. The method of claim 16, further comprising attaching each roofing panel to rafters of the roof with fasteners, and wherein the body of each roofing panel further comprises a nail sealable material adapted to substantially seal openings created therein by the fasteners.

18. A method, comprising:
mixing a shredded or crushed polymer material with a granular filler material to form a mixture;
extruding the mixture under heat at a temperature selected based upon a melting temperature of the polymer material, forming an extrudate that is moved along a processing path;
forming watershedding features along peripheral side edges of the extrudate; and
cutting, pressing or stamping the extrudate to form roofing panels of a selected length and/or configuration;
wherein each of the roofing panels includes an upper surface adapted to be exposed to weather.

19. The method of claim 18, further comprising thinning the extrudate and cooling the extrudate prior to cutting, pressing or stamping the extrudate to form the roofing panels.

20. The method of claim 18, further comprising adding an ultraviolet stabilizer to the mixture prior to extruding the mixture.

21. The method of claim 18, further comprising applying an ultraviolet blocking film, an ultraviolet blocking paint, a colored, patterned, or tinted film, a metallized film, an impact resistant coating, or combinations thereof over the upper surface of the roofing panels.

22. The method of claim 18, further comprising positioning the extrudate over a bottom layer of a substrate material as the extrudate is moved along its processing path, and pressing or fusing the extrudate with the bottom layer.

23. A roof structure, comprising:
a plurality of panels each configured to extend across a section of the roof structure, each panel comprising:
a body comprising:
at least one stepped portion defining a headlap portion or sidelap portion;
at least one overlap portion defining an opposing lower portion or sidelap portion of the body; and
at least one watershedding feature located along at least one peripheral edge portion of the body and configured to convey water along at least one drainage path;
wherein the at least one overlap portion of each panel is configured to overlap the at least one stepped portion of an adjacent panel;
wherein the body comprises a mixture having at least one filler material and at least one binder material; and
wherein the at least one watershedding feature of each panel is configured to cooperate with a corresponding watershedding feature of the adjacent panel to reduce migration of water between each panel and adjacent panel.

24. The roof structure of claim 23, wherein the at least one binder material comprises recycled plastics, mixed plastics, commingled plastics, unwashed plastics, plastic films, contaminated plastics, agricultural films and/or geotextiles or geo-membranes, oriented strand board binders, starches, lignins, adhesives, asphaltic binders, cement and/or combinations thereof.

25. The roof structure of claim 23, further comprising a sealant material positioned between the overlap portion of each panel and the stepped portion of the adjacent panel.

26. The roof structure of claim 23, wherein the at least one watershedding feature further comprises a drip edge or water trough positioned along at least one peripheral edge of the body of each panel.

27. The roof structure of claim 23, wherein the at least one filler material comprises sand, perlite, sodium bentonite, asphalt shingle materials, concrete, a recycled material, including recycled shingle materials, rice hulls, hemp, cellulose, foams, or combinations thereof.

28. The roof structure of claim 23, wherein the at least one overlap portion comprises a projecting portion and the at least one stepped portion comprises a recessed portion; wherein the projecting portion overlaps the recessed portion so as to form a headlap seam when each panel and adjacent panel are installed on the section of the roof structure.

29. The roof structure of claim 23, wherein the panels of the plurality of panels are configured to be installed in overlapping courses of panels along the roof structure, wherein the panels of each course of panels are coupled together along adjacent side edges thereof, and wherein the panels of a higher course of panels positioned in a diagonally offset arrangement from the panels of a lower course of panels.

30. The roof structure of claim 29, further comprising a sealant material applied along at least one of the stepped portion and the at least one portion of each panel of the higher course of panels and diagonally offset adjacent panels of the lower course of panels, the sealant material configured to form a substantially water-tight seal along a headlap seam defined therebetween.
